(19) United States
(12) Patent Application Publication
(10) Pub. No.: US 2026/0300862 A1
(43) Pub. Date: Oct. 1, 2026

(54) INFORMATION PROCESSING DEVICE

(71) Applicant: TOYOTA JIDOSHA KABUSHIKI KAISHA, Toyota-shi (JP)

(72) Inventors: Mitsuhiro ONO, Yokosuka-shi (JP); Junya Oikawa, Kawasaki-shi (JP); Hiroki Kano, Yokohama-shi (JP); Kiminobu Makino, Tokyo (JP); Naoto Matsumoto, Tokyo (JP); Takuya Yoshida, Tokyo (JP)

(73) Assignee: TOYOTA JIDOSHA KABUSHIKI KAISHA, Toyota-shi (JP)

(21) Appl. No.: 19/459,524

(22) Filed: Jan. 26, 2026

(30) Foreign Application Priority Data
Mar. 25, 2025 (JP) 2025-050422

(51) Int. Cl. G06Q 10/0631; G06Q 50/06

(52) U.S. Cl. CPC G06Q 10/06315; G06Q 50/06; G06Q 2220/00

(57) ABSTRACT

The information processing device includes a control unit configured to: acquire power generation information and power demand information, the power generation information indicating forecast values of an amount of power generated for each time period by a power plant that generates power using renewable energy, and the power demand information indicating forecast values of an amount of power demanded for each time period by consumers supplied with power from the power plant; forecast a surplus time period in which surplus power occurs; and transmit an instruction to a device located within a predetermined area around the power plant to provide a second information processing service to a user of a predetermined vehicle during the surplus time period, the second information processing service having a higher processing load than a first information processing service that is provided during a non-surplus time period in which the surplus power does not occur.

### CROSS-REFERENCE TO RELATED APPLICATION

This application claims priority to Japanese Patent Application No. 2025-050422 filed on Mar. 25, 2025. The disclosure of the above-identified application, including the specification, drawings, and claims, is incorporated by reference herein in its entirety.

### BACKGROUND

### 1. Technical Field

The present disclosure relates to information processing devices configured to control a device that provides services to a vehicle.

### 2. Description of Related Art

There are techniques for planning processes to be performed according to power demand. For example, Japanese Unexamined Patent Application Publication No. 2023-83813 (JP 2023-83813 A) discloses a power management system that creates a storage battery control plan including schedule information for the charging and discharging state of a storage battery corresponding to a power demand forecast value for a given day calculated based on actual power demand data, and that controls the charging and discharging state of the storage battery on that day.

### SUMMARY

It is an object of the present disclosure to effectively utilize surplus power generated in excess of power demand.

One aspect of the present disclosure is an information processing device including a control unit configured to:

acquire power generation information and power demand information, the power generation information indicating forecast values of an amount of power generated for each time period by a power plant that generates power using renewable energy, and the power demand

information indicating forecast values of an amount of power demanded for each time period by consumers who are supplied with power from the power plant; forecast a surplus time period, the surplus time period being a time period in which surplus power occurs when the amount of power indicated by the power generation information exceeds the amount of power indicated by the power demand information; and transmit an instruction to a device located within a predetermined area around the power plant to provide a second information processing service to a user of a predetermined vehicle during the surplus time period, the second information processing service having a higher processing load than a first information processing service that is provided during a non-surplus time period in which the surplus power does not occur.

Another aspect of the present disclosure is an information processing device including a control unit configured to:

acquire a result of forecasting a surplus time period, the surplus time period being a time period in which surplus power occurs when an amount of power generated by a power plant that generates power using renewable energy exceeds an amount of power demanded by consumers who are supplied with power from the power plant; and transmit an instruction to a device located within a predetermined area around the power plant to provide a second information processing service to a user of a predetermined vehicle during the surplus time period indicated by the result, the second information processing service having a higher processing load than a first information processing service that is provided during a non-surplus time period in which the surplus power does not occur.

Other aspects include an information processing method performed by the above information processing device, a program that causes a computer to perform the information processing method, and a computer-readable storage medium storing the program in a non-transitory manner.

The information processing device according to the present disclosure can effectively utilize surplus power generated in excess of power demand.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a network configuration including a server device according to an embodiment;

FIG. 2 is a diagram illustrating components included in the server device according to the embodiment;

FIG. 3 is a flowchart of a process performed by the server device according to the embodiment to forecast the occurrence of surplus power; and

FIG. 4 is a flowchart of a process performed by the server device according to the embodiment to cause execution of processing in accordance with the occurrence of surplus power.

### DETAILED DESCRIPTION OF EMBODIMENTS

### Overview

Because the amount of power generated at renewable energy plants varies with the weather, there is a need to effectively utilize surplus power across various services.

In this regard, there have conventionally been techniques for planning processes to be performed according to forecast power demand.

For example, a conventional power management system can create a storage battery control plan including schedule information for the charging and discharging state of a storage battery corresponding to a power demand forecast value, and can control the charging and discharging of the storage battery accordingly.

Specifically, a conventional power management system creates a storage battery control plan including schedule information for the timing of charging and discharging of a storage battery on the next day, based on a forecast solar power generation value for the next day and consumer setting information. The power management system then controls the charging and discharging of the storage battery based on a result of comparing the state of charge (SOC) indicated in the storage battery control plan with the current remaining charge (current SOC) of the storage battery.

However, there is room for improvement in conventional power management systems. For example, a conventional power management system forecasts future solar power generation and power demand and creates a storage battery control plan based on the forecast, but does not take into account a control method for effectively utilizing surplus power that occurs when the solar power generation exceeds the power demand. Specifically, even when the amount of solar power generation exceeds the power demand, the conventional power management system merely performs charging of the storage battery within the range of the power demand. However, in order to effectively utilize surplus power, it is desirable that, when the amount of power generated by a power plant using renewable energy such as solar power exceeds the power demand, some process be performed to consume the surplus power, rather than merely charging a storage battery. For example, a process that can consume surplus power includes relatively high-load processing involved in various services provided to connected cars. When, in controlling a device that provides such services to vehicles, relatively high-load processing within those services is performed during a time period in which surplus power occurs, this may lead to effective utilization of the surplus power. Accordingly, it is desirable that the information processing device be capable of giving appropriate instructions to devices, such as those that provide services to connected cars, to perform predetermined processing for effectively utilizing surplus power.

An information processing device according to one aspect of the present disclosure includes a control unit configured to:

acquire power generation information and power demand information, the power generation information indicating forecast values of an amount of power generated for each time period by a power plant that generates power using renewable energy, and the power demand information indicating forecast values of an amount of power demanded for each time period by consumers who are supplied with power from the power plant; forecast a surplus time period, the surplus time period being a time period in which surplus power occurs when the amount of power indicated by the power generation information exceeds the amount of power indicated by the power demand information; and transmit an instruction to a device located within a predetermined area around the power plant to provide a second information processing service to a user of a predetermined vehicle during the surplus time period, the second information processing service having a higher processing load than a first information processing service that is provided during a non-surplus time period in which the surplus power does not occur.

The power generation information refers to forecast values of the amount of power generated for each time period by a power plant that generates power using renewable energy. For example, the power generation information indicates hourly forecast values of the amount of power that a given power plant is expected to generate.

The power demand information refers to forecast values of the amount of power demanded for each time period by consumers who are supplied with power from a power plant that generates power using renewable energy. For example, the power demand information represents hourly forecast values of the amount of power that consumers supplied with power from the given power plant are expected to demand.

The surplus power refers to the amount of power that a power plant is forecast to generate in excess of the amount of power expected to be consumed by consumers.

A surplus time period refers to a time period in which surplus power is forecast to occur at the power plant. The surplus time period may be expressed, for example, in units of 15 minutes, 30 minutes, or one hour.

A non-surplus time period refers to a time period in which surplus power is forecast not to occur at the power plant. The non-surplus time period may be expressed, for example, in units of 15 minutes, 30 minutes, or one hour.

The first information processing service refers to a predetermined information processing service that is provided to a user of a vehicle by a device located within an area around a given power plant that generates power using renewable energy. For example, the first information processing service may be a service that provides certain information output based on data acquired from the user of the vehicle.

The second information processing service refers to a service that has a higher processing load than the first information processing service. Preferably, the second information processing service may be the same type of service as the first information processing service but provides a higher level of quality than the first information processing service.

The control unit causes a device located within a predetermined area around the power plant to provide, during a surplus time period, the second information processing service having a higher processing load than the first information processing service that the device provides during a non-surplus time period, to a user of a predetermined vehicle.

As described above, the information processing device according to the present disclosure can cause a higher-load information processing service to be provided to a vehicle 10 when surplus power is occurring.

With this configuration, the information processing device according to the present disclosure can effectively utilize surplus power generated in excess of the power demand.

An information processing device according to another aspect of the present disclosure includes a control unit configured to:

acquire a result of forecasting a surplus time period, the surplus time period being a time period in which surplus power occurs when an amount of power generated by a power plant that generates power using renewable energy exceeds an amount of power demanded by consumers who are supplied with power from the power plant; and transmit an instruction to a device located within a predetermined area around the power plant to provide a second information processing service to a user of a predetermined vehicle during the surplus time period indicated by the result, the second information processing service having a higher processing load than a first information processing service that is provided during a non-surplus time period in which the surplus power does not occur.

In this configuration, the information processing device according to the present disclosure acquires a result of forecasting a surplus time period in which surplus power occurs, and, based on the acquired forecast result, causes a device located within a predetermined area around the power plant to provide, during the surplus time period, the second information processing service having a higher processing load than the first information processing service that the device provides during a non-surplus time period, to a user of a predetermined vehicle.

The second information processing service may be an information processing service in which acquisition of data accumulated in the vehicle during the non-surplus time period from the vehicle is added to the first information processing service.

With this configuration, the information processing device according to the present disclosure can perform, during a surplus time period, data acquisition that increases the overall processing load when added to the first information processing service.

The first information processing service may be an information processing service that provides the user with an output result corresponding to a predetermined input from a machine learning model that has been trained by the device during the surplus time period, and the second information processing service may be an information processing service in which the device performs at least training of the machine learning model.

With this configuration, the information processing device according to the present disclosure can perform training of a machine learning model involving a higher processing load during a surplus time period.

The first information processing service may be an information processing service in which the device performs encryption processing on data acquired from the user, and the second information processing service may be an information processing service in which the device performs stronger encryption processing on the data acquired from the user than the encryption processing of the first information processing service.

With this configuration, the information processing device according to the present disclosure can perform stronger encryption processing involving a higher processing load during a surplus time period.

Hereinafter, a specific embodiment of the present disclosure will be described with reference to the drawings. Unless otherwise specified, the hardware configurations, module configurations, and functional configurations described in the embodiment are not intended to limit the technical scope of the present disclosure to those configurations.

### Embodiment

### Overview

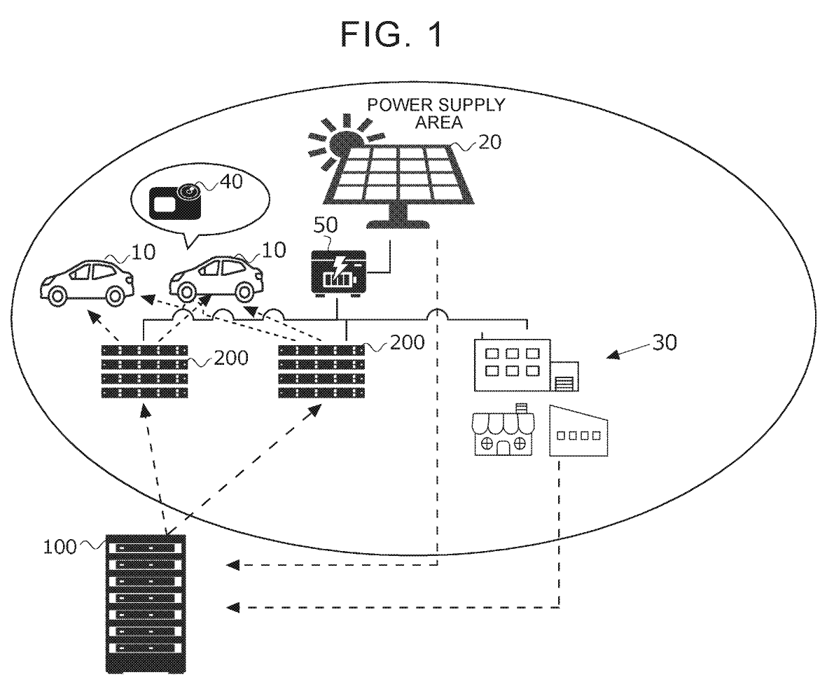

The configuration of a network including a server device according to an embodiment will be described with reference to FIG. 1. FIG. 1 is a diagram showing a network configuration including a server device 100 according to the embodiment. An information processing device according to one aspect of the present disclosure is implemented as the server device 100.

A device 200 and a consumer 30 receive power from a power plant 20. The power from the power plant 20 may be stored in a storage battery 50 before being supplied to the device 200 and the consumer 30.

The server device 100 communicates with the power plant 20 and the consumer 30 via a wide area network. The consumer 30 is an electricity consumer that receives power from the power plant 20. The server device 100 communicates with the device 200 via the wide area network. The server device 100 also communicates with an in-vehicle terminal 40 via the wide area network.

The device 200 receives instructions from the server device 100 and outputs a service to the in-vehicle terminal 40 mounted on a vehicle 10. A user of the vehicle 10 enjoys the service provided by the device 200 through the in-vehicle terminal 40. The server device 100 may receive a service request from the user of the vehicle 10 via the in-vehicle terminal 40 and transmit instructions to the device 200 based on the request.

As described above, the server device 100 can cause the device 200 to provide a predetermined service to the vehicle 10. The power consumed by services provided from the device 200 etc. is basically supplied from the power plant 20 that provides power to the area in which the vehicle 10 is traveling. The power plant 20, for example, generates electricity using renewable energy, and its output fluctuates significantly depending on weather conditions. For example, in the case of a solar power plant, the amount of power generation increases under good weather conditions. At that time, the amount of power generated by the power plant 20 exceeds the amount of power demanded by consumers located within the area that is supplied with power from the power plant 20, resulting in surplus power generation.

In such a case, the server device 100 causes the device 200 to provide a high-load information processing service that effectively consumes the surplus power. The surplus power generated by the power plant 20 can thus be effectively utilized.

### Configuration of Server Device

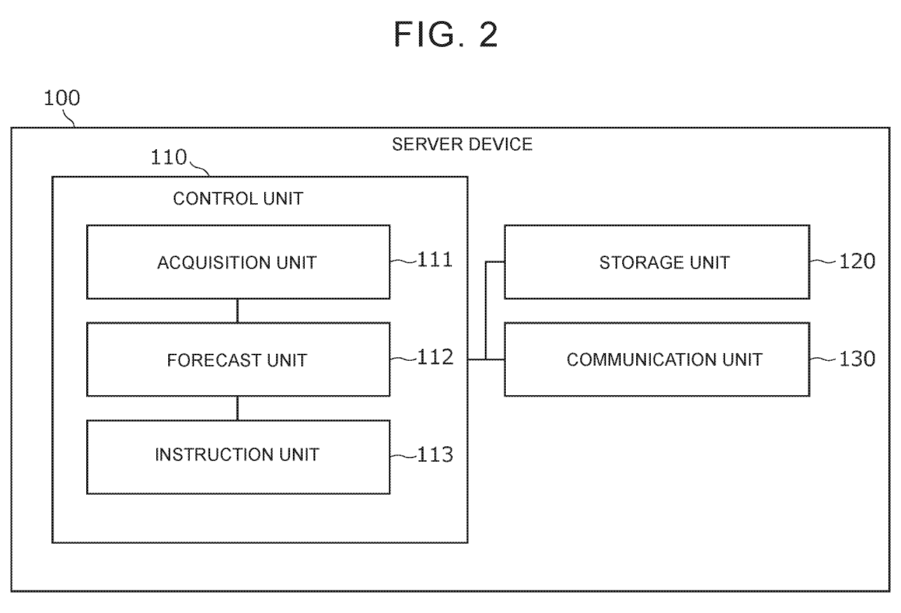

Next, the hardware and software configurations of the system including the server device 100 will be described. FIG. 2 is a diagram illustrating components included in the server device 100 according to the present embodiment.

The server device 100 can be configured as a computer that includes a processor (such as a central processing unit (CPU) or a graphics processing unit (GPU)), a main storage device (such as random access memory (RAM) or read-only memory (ROM)), and an auxiliary storage device (such as erasable programmable read-only memory (EPROM), hard disk drive, or removable medium). The auxiliary storage device stores an operating system (OS), various programs, various tables, etc. Various functions (software modules) for predetermined purposes, as described later, can be implemented by executing the programs stored in the auxiliary storage device. However, part or all of the functions may alternatively be implemented as hardware modules by using hardware circuits such as application-specific integrated circuits (ASICs) or field-programmable gate arrays (FPGAs).

The server device 100 includes a control unit 110, a storage unit 120, and a communication unit 130.

The control unit 110 is a processing unit that implements various functions of the server device 100 by executing predetermined programs. The control unit 110 can be implemented by a hardware processor such as a CPU. The control unit 110 may include RAM, ROM, and cache memory.

In the present embodiment, the control unit 110 of the server device 100 includes three software modules: an acquisition unit 111, a forecast unit 112, and an instruction unit 113. Each software module may be implemented by the control unit 110 (for example, the CPU) executing a program stored in the storage unit 120. The information processing performed by the software modules is equivalent to the information processing performed by the control unit 110 (for example, the CPU).

The acquisition unit 111 acquires power generation information from the power plant 20. The power generation information indicates forecast values of the amount of power generated by the power plant 20 for each time period.

The acquisition unit 111 also acquires power demand information from an external device. The power demand information indicates forecast values of the amount of power demanded for each time period by consumers 30 located within the area that is supplied with power from the power plant 20.

The forecast unit 112 compares the power generation information for each given time period with the power demand information for the same time period to forecast surplus time periods. The term "surplus time period" refers to a time period in which surplus power occurs. Specifically, the forecast unit 112 forecasts a time period as a surplus time period when the amount of power generation indicated by the power generation information exceeds the amount of power demand indicated by the power demand information.

The instruction unit 113 transmits an instruction to the device 200 to provide, during a surplus time period, a second information processing service having a higher processing load than a first information processing service performed during a non-surplus time period, to the user of the vehicle 10 located within a predetermined area around the power plant 20. A time period in which no surplus power occurs is referred to as a non-surplus time period.

For example, when the instruction unit 113 determines that the current time is within a surplus time period, it may transmit an instruction to the device 200 to improve the accuracy of route guidance compared with the accuracy of route guidance provided during non-surplus time periods.

The storage unit 120 serves as means for storing information and is constituted by a storage medium such as RAM, magnetic disk, or flash memory. The storage unit 120 stores programs executed by the control unit 110 and data used by those programs.

The communication unit 130 is a wireless communication interface for connecting the server device 100 to an external network. The communication unit 130 is configured to communicate with external devices via, for example, a wireless local area network (LAN) or a third-generation (3G), fourth-generation (4G), or fifth-generation (5G) cellular network.

The configuration shown in FIG. 2 is merely an example. Part or all of the illustrated functions may instead be implemented using dedicated circuitry. The programs may be stored or executed using any combination of main and auxiliary storage devices other than those shown in the figure.

### Processing Performed by Server Device

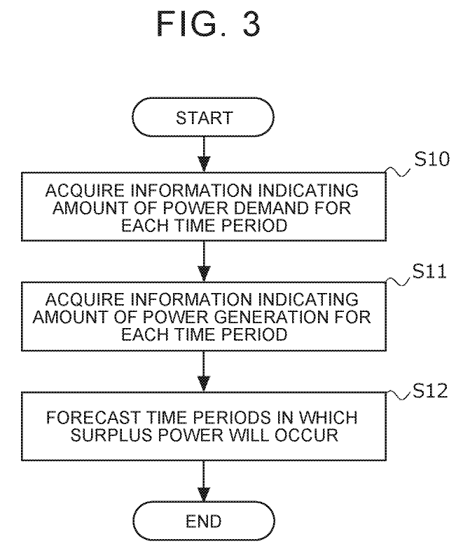

Next, the specific processing performed by the server device 100 according to one embodiment of the present disclosure will be described. FIG. 3 is a flowchart of a process performed by the server device 100 according to the embodiment to forecast the occurrence of surplus power.

The server device 100 starts step S10 at predetermined intervals. For example, the server device 100 may start step S10 every hour. Alternatively, the server device 100 may execute step S10 when some input operation is performed on the server device 100.

First, in step S10, the acquisition unit 111 acquires power demand information from an external device. The power demand information indicates forecast values of the amount of power demanded (power demand) for each time period by the consumers 30 located within the area that is supplied with power from the power plant 20

(hereinafter referred to as "power supply area"). The power demand information may be calculated based on the flow of people expected to be present in the power supply area during the forecast time period, based on the amount of information processing expected to be performed in the power supply area during the forecast time period, or based on a combination of both.

Next, in step S11, the acquisition unit 111 acquires power generation information from the power plant 20. The power generation information indicates forecast values of the amount of power generated by the power plant 20 for each time period. The power generation information may be calculated based on a weather forecast for the area surrounding the power plant 20. For example, when the weather in the area surrounding the power plant 20 is forecast to be clear during a forecast time period, the amount of power generation during that time period may be estimated to be greater than a predetermined value, whereas when the weather in the area surrounding the power plant 20 is forecast to be rainy, the amount of power generation during that time period may be estimated to be smaller than the predetermined value.

Next, in step S12, the forecast unit 112 forecasts surplus time periods, that is, time periods in which surplus power will occur at the power plant 20. Specifically, the forecast unit 112 compares the amount of power indicated by the power demand information acquired in step S10 with the amount of power indicated by the power generation information acquired in step S11. When the amount of power indicated by the power generation information exceeds the amount of power indicated by the power demand information during a given time period, the forecast unit 112 determines that surplus power will occur at the power plant 20 during that time period.

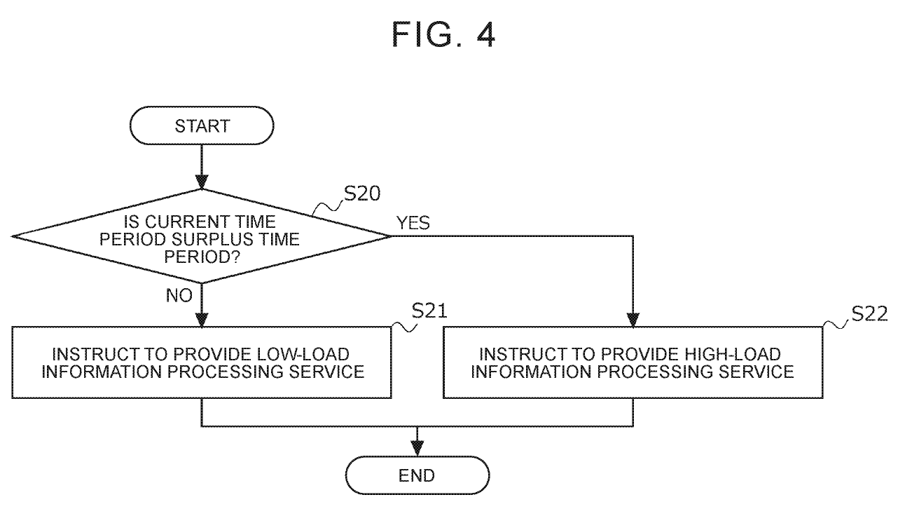

Next, a process in which the device 200 is caused to provide a predetermined service according to whether the current time period is a surplus time period will be described. FIG. 4 is a flowchart of a process performed by the server device 100 according to the present embodiment to cause execution of processing in accordance with the occurrence of surplus power. FIG. 4 illustrates a process in which the server device 100 issues an instruction to the device 200, which outputs a service to the in-vehicle terminal 40 that provides the service to the user of the vehicle 10, to perform higher-load processing during a surplus time period. Steps S20 to S22 in FIG. 4 are repeatedly executed at predetermined time intervals.

First, in step S20, the instruction unit 113 determines whether the current time period is a surplus time period. Specifically, the instruction unit 113 acquires the current time from an internal clock and determines whether the acquired current time corresponds to any of the surplus time periods forecast by the forecast unit 112 in step S12. When the instruction unit 113 determines that the current time period is a surplus time period, a positive determination is made in this step.

When a negative determination is made in step S20, the process proceeds to step S21.

When a positive determination is made in step S20, the process proceeds to step S22.

When the process proceeds to step S21, the instruction unit 113 transmits an instruction to the device 200, which provides a service to the user of the vehicle 10, to provide a relatively low-load information processing service.

When the process proceeds to step S22, the instruction unit 113 transmits an instruction to the device 200 to provide a relatively high-load information processing service.

### Details of Services Provided

Next, the process in which the server device 100 transmits an instruction to the device 200 that provides a service to the user of the vehicle 10 will be described in detail. The following describes steps S21, S22 in FIG. 4 in detail.

When the process proceeds to step S21, the instruction unit 113 transmits an instruction to the device 200, which outputs a service to the in-vehicle terminal 40 of the vehicle 10, to output to the in-vehicle terminal 40 an information processing service that uses data acquired during a surplus time period. That is, when the information processing service output by the device 200 includes a phase of acquiring data and a phase of providing the result of processing using the acquired data, the instruction unit 113 instructs the device 200 to execute the latter phase.

The in-vehicle terminal 40 is a terminal that provides a predetermined service to the user, and the processing involved in the provided service is performed by any one of a plurality of devices 200. The result of the processing performed by the device 200 is output to the in-vehicle terminal 40.

For example, in a service that analyzes video from a drive recorder and notifies the user of the vehicle of a predetermined event, when the current time period is a non-surplus time period, the instruction unit 113 causes execution of the following processing: analyzing previously acquired drive recorder video, and notifying the user of the vehicle when the predetermined event is detected.

When the process proceeds to step S22, the instruction unit 113 transmits an instruction to the device 200 to acquire data accumulated by the vehicle 10 during a non-surplus time period and to provide an information processing service using the acquired data. That is, when the information processing service provided by the device 200 includes a phase of acquiring data and a phase of providing the result of processing using the acquired data, the instruction unit 113 instructs the device 200 to execute both phases. For example, in the service that analyzes video from a drive recorder and notifies the user of the vehicle of a predetermined event, when the current time period is a surplus time period, the instruction unit 113 causes execution of the following processing: acquiring drive recorder video, analyzing the acquired video, and notifying the user of the vehicle when the predetermined event is detected. This is because the process of acquiring drive recorder video from the vehicle 10 involves a relatively large amount of data transmission and consumes a certain amount of power in the area where the device 200 is installed, and is therefore desirably performed during a surplus time period.

As described above, during a surplus time period, the server device 100 causes the device 200 that provides a service to the user of the vehicle 10 to perform a high-load information processing service. Accordingly, the server device 100 can effectively utilize surplus power generated in excess of power demand.

### First Modification

The above embodiment illustrates the case where the information processing service provided by the device 200 includes a phase of acquiring data and a phase of providing the result of processing using the acquired data. In the above embodiment, the server device 100 instructs the device 200 to execute the latter phase during a non-surplus time period, and to execute both phases during a surplus time period. It is also conceivable that the information processing service provided by the device 200 may use a machine learning model. Accordingly, a first modification illustrates a case where the device 200 provides an information processing service that uses a machine learning model.

The following describes in detail the processing performed in steps S21, S22 in FIG. 4 instead of the processing described in the above embodiment.

When the process proceeds to step S21, the instruction unit 113 transmits an instruction to the device 200, which provides a service to the user of the vehicle 10, to perform provision of an output from a trained machine learning model. That is, when the information processing service provided by the device 200 includes a phase of training a machine learning model and a phase of obtaining an output corresponding to a certain input to the trained machine learning model, the instruction unit 113 instructs the device 200 to execute the latter phase.

When the process proceeds to step S22, the instruction unit 113 transmits an instruction to the device 200 to perform both training of the machine learning model and provision of an output from the trained machine learning model. That is, when the information processing service provided by the device 200 includes a phase of training a machine learning model and a phase of obtaining an output corresponding to a certain input to the trained machine learning model, the instruction unit 113 instructs the device 200 to execute both phases.

As described above, during a surplus time period, the server device 100 causes the device 200, which provides a service to the user of the vehicle 10, to perform training of a machine learning model that involves a high processing load.

### Second Modification

The first modification illustrates the case where the device 200 provides an information processing service that uses a machine learning model. It is also conceivable that the information processing service provided by the device 200 may perform encryption processing on data acquired from the vehicle 10. Accordingly, a second modification illustrates a case where the device 200 provides an information processing service that performs encryption processing.

The following describes in detail the processing performed in steps S21, S22 in FIG. 4 instead of the processing described in the above embodiment.

When the process proceeds to step S21, the instruction unit 113 transmits an instruction to the device 200, which provides a service to the user of the vehicle 10, to perform encryption processing at a predetermined level on data acquired from the vehicle 10. The encryption method used for the encryption processing may be ElGamal encryption, Rivest–Shamir–Adleman (RSA) encryption, or Advanced Encryption Standard (AES) encryption. Alternatively, the encryption method used for the encryption processing may be elliptic curve cryptosystem (ECC) encryption.

When the process proceeds to step S22, the instruction unit 113 transmits an instruction to the device 200 to perform encryption processing that is stronger than the encryption processing performed during a non-surplus time period. The instruction unit 113 may instruct the device 200 to perform higher-quality encryption processing using the same encryption method as that used during a non-surplus time period. The instruction unit 113 may instruct the device 200 to perform encryption processing using a different encryption method that involves a higher processing load than the encryption method used during a non-surplus time period.

As described above, during a surplus time period, the server device 100 causes the device 200, which provides a service to the user of the vehicle 10, to perform stronger encryption processing that involves a high processing load.

### Third Modification

The second modification illustrates the case where the device 200 provides an information processing service that performs encryption processing. It is also conceivable that the information processing service provided by the device 200 may perform video processing. Accordingly, a third modification illustrates a case where the device 200 provides an information processing service that performs video processing. The following describes the processing performed in steps S21, S22 in FIG. 4 instead of the processing described in the above embodiment.

For example, when the process proceeds to step S21, the instruction unit 113 transmits an instruction to the device 200 to perform video processing at a predetermined resolution.

When the process proceeds to step S22, the instruction unit 113 may transmit an instruction to the device 200 to perform video processing at a higher resolution than when the process proceeds to step S21.

As described above, during a surplus time period, the server device 100 causes the device 200, which provides a service to the user of the vehicle 10, to perform higher-resolution video processing that is involves a high processing load.

### Fourth Modification

The third modification illustrates the case where the device 200 provides an information processing service that performs video processing. It is also conceivable that the device 200 may provide, as a higher-load information processing service, a service in which statistical processing is added to a primary information processing service. Accordingly, a fourth modification illustrates a case where the device 200 provides, as a higher-load information processing service, an information processing service with additional statistical processing. The following describes the processing performed in steps S21, S22 in FIG. 4 instead of the processing described in the above embodiment.

For example, when the process proceeds to step S21, the instruction unit 113 transmits an instruction to the device 200 to provide a first information processing service alone to the vehicle 10. The vehicle 10 is a vehicle located within a predetermined area around the power plant 20.

When the process proceeds to step S22, the instruction unit 113 transmits an instruction to the device 200 to provide a second information processing service to the vehicle 10. The second information processing service is a service in which a statistical processing service related to the first information processing service is added to the first information processing service.

As described above, during a surplus time period, the server device 100 causes the device 200, which provides a service to the user of the vehicle 10, to perform an information processing service with additional statistical processing that involves a higher processing load.

### Other Modifications

The above embodiment is merely an example, and the present disclosure may be modified as appropriate without departing from the spirit and scope of the disclosure. For example, the processes and means described in the present disclosure can be combined as desired as long as no technical inconsistencies arise.

The information processing service provided by the device 200 in the embodiment, that is, the information processing service that includes a phase of acquiring data and a phase of providing the result of processing using the acquired data, may be, for example, a service that acquires data detected by a sensor mounted on the vehicle 10, generates a three-dimensional (3D) map for autonomous driving control, and provides the 3D map to the vehicle 10. For example, the instruction unit 113 may instruct the device 200 to perform both the acquisition of data detected by a sensor of the vehicle and the generation and provision of the 3D map to the vehicle 10 during a surplus time period. The instruction unit 113 may instruct the device 200 to perform the generation and provision of the 3D map to the vehicle 10 during a non-surplus time period.

In the above embodiment, the server device 100 separately forecasts whether surplus power will occur, and then determines, at predetermined intervals, whether the current time period is a surplus time period. Each time it is determined that the current time period is a surplus time period, the server device 100 instructs the device 200 to perform high-load processing. However, once the server device 100 has forecast whether surplus power will occur, it may instruct the device 200 in advance to perform high-load processing during a forecast surplus time period. Then, when it is determined that the current time period is a surplus time period, the device 200 may perform the high-load processing in accordance with the instruction received in advance from the server device 100.

In the first modification, when the device 200 provides an information processing service that uses machine learning, the instruction unit 113 may perform the following operation. When it is determined that the current time period is a surplus time period, the instruction unit 113 may instruct the device 200 to increase the number of layers used in the machine learning computation compared to the number of layers used in the machine learning computation during a non-surplus time period.

The service provided by the device 200 to the vehicle 10 may be a route guidance service. When the device 200 provides an information processing service for route guidance to the user of the vehicle 10, the instruction unit 113 may perform the following operation. When it is determined that the current time period is a surplus time period, the instruction unit 113 may transmit an instruction to the device 200 to perform route guidance at higher accuracy that involves a higher processing load than rouge guidance at normal accuracy. Conversely, when it is determined that the current time period is a non-surplus time period, the instruction unit 113 may transmit an instruction to the device 200 to perform route guidance at normal accuracy that involves a lower processing load.

The present disclosure may also be implemented by supplying a computer program that implements the functions described in the above embodiment to a computer, and causing one or more processors included in the computer to read and execute the program. Such a computer program may be provided to the computer via a non-transitory computer-readable storage medium connectable to a system bus of the computer, or may be provided to the computer via a network. The non-transitory computer-readable storage medium may include, for example, any type of disk such as a magnetic disk (floppy (registered trademark) disk, hard disk drive (HDD), etc.) or an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read-only memory (EEPROM), a magnetic card, a flash memory, an optical card, or any type of medium suitable for storing electronic instructions.

What is claimed is:

1. An information processing device comprising a control unit configured to
acquire power generation information and power demand information, the power generation information indicating forecast values of an amount of power generated for each time period by a power plant that generates power using renewable energy, and the power demand information indicating forecast values of an amount of power demanded for each time period by consumers who are supplied with power from the power plant,
forecast a surplus time period, the surplus time period being a time period in which surplus power occurs when the amount of power indicated by the power generation information exceeds the amount of power indicated by the power demand information, and
transmit an instruction to a device located within a predetermined area around the power plant to provide a second information processing service to a user of a predetermined vehicle during the surplus time period, the second information processing service having a higher processing load than a first information processing service that is provided during a non-surplus time period in which the surplus power does not occur.

2. An information processing device comprising a control unit configured to
acquire a result of forecasting a surplus time period, the surplus time period being a time period in which surplus power occurs when an amount of power generated by a power plant that generates power using renewable energy exceeds an amount of power demanded by consumers who are supplied with power from the power plant, and
transmit an instruction to a device located within a predetermined area around the power plant to provide a second information processing service to a user of a predetermined vehicle during the surplus time period indicated by the result, the second information processing service having a higher processing load than a first information processing service that is provided during a non-surplus time period in which the surplus power does not occur.

3. The information processing device according to claim 1, wherein the second information processing service is an information processing service in which acquisition of data accumulated in the vehicle during the non-surplus time period from the vehicle is added to the first information processing service.

4. The information processing device according to claim 1, wherein:
the first information processing service is an information processing service that provides the user with an output result corresponding to a predetermined input from a machine learning model that has been trained by the device during the surplus time period; and
the second information processing service is an information processing service in which the device performs at least training of the machine learning model.

5. The information processing device according to claim 1, wherein:
the first information processing service is an information processing service in which the device performs encryption processing on data acquired from the user; and
the second information processing service is an information processing service in which the device performs stronger encryption processing on the data acquired from the user than the encryption processing of the first information processing service.
